(19) United States
(12) Patent Application Publication
(10) Pub. No.: US 2013/0070750 A1
(43) Pub. Date: Mar. 21, 2013

(54) METHOD AND APPARATUS FOR ACQUIRING RECEPTION SYNCHRONIZATION IN LOCAL WIRELESS COMMUNICATION SYSTEM

(71) Applicants: Byoung Hak KIM, Daejeon (KR); Jaehwan KIM, Daejeon (KR); Mi Kyung OH, Daejeon (KR); Sangjae LEE, Daejeon (KR); Seung Sik LEE, Daejeon (KR); cheol-ho SHIN, Daejeon (KR); Young Ae JEON, Daejeon (KR); Sangsung CHOI, Daejeon (KR)

(72) Inventors: Byoung Hak KIM, Daejeon (KR); Jaehwan KIM, Daejeon (KR); Mi Kyung OH, Daejeon (KR); Sangjae LEE, Daejeon (KR); Seung Sik LEE, Daejeon (KR); cheol-ho SHIN, Daejeon (KR); Young Ae JEON, Daejeon (KR); Sangsung CHOI, Daejeon (KR)

(73) Assignee: Electronics and Telecommunications Research Institute, Daejeon (KR)

(21) Appl. No.: 13/600,269

(22) Filed: Aug. 31, 2012

(30) Foreign Application Priority Data
Sep. 15, 2011 (KR) 10-2011-0093117

(51) Int. Cl. H04W 56/00

(52) U.S. Cl. 370/350

(57) ABSTRACT

In a local wireless communication system, a reception signal including an STF (short training field) in which a plurality of patterns are repeatedly transmitted is received, the STF including a first number of STF patterns and a second number of STF patterns, the second number of STF patterns having an opposite code to that of the first number of STF patterns. In a first frequency offset estimation and correction process and a second frequency offset estimation and correction process, frequency offset estimation is performed on a plurality of STF patterns to acquire a phase error of each sample constituting the STF patterns, and the frequency of the STF patterns is corrected based on the acquired phase error. Cross correlation is performed on a predetermined number of STF patterns, among a plurality of STF patterns output subsequent to the frequency offset estimation and correction, to detect frame timing.

### CROSS-REFERENCE TO RELATED APPLICATION

This application claims priority to and the benefit of Korean Patent Application No. 10-2011-0093117 filed in the Korean Intellectual Property Office on Sep. 15, 2011, the entire contents of which are incorporated herein by reference.

### BACKGROUND OF THE INVENTION

(a) Field of the Invention

The present invention relates to a method and apparatus for acquiring synchronization, and more particularly, to a method and apparatus for acquiring synchronization for signal reception in a local wireless communication system.

(b) Description of the Related Art

Orthogonal frequency division multiplexing (OFDM) is used in a wireless communication system because it makes efficient use of limited frequency resources and provides a high data transmission rate.

Because of this merit, OFDM is used as the core technology of wireless access systems, such as IEEE (Institute of Electrical and Electronics Engineers) 802.16 and LTE (Long Term Evolution). In OFDM, however, signals are simultaneously transmitted through a plurality of subcarriers. Thus, if a time or frequency synchronization error exists, inter-subcarrier interference as well as interference between adjacent signals exist, thereby significantly degrading performance. Such a synchronization error leads to significant degradation of the handoff performance of a terminal. For proper handoff support, strict time and frequency synchronizations are required even between base stations.

A short training symbol and a long training symbol are repeatedly included and transmitted in a preamble to achieve time and frequency synchronization. In this case, a method of detecting a boundary between a short training symbol interval and a long training symbol interval by performing cross correlation and peak detection are performed using the short training symbol or the long training symbol as a reference signal may be used.

Since such a method is a synchronization algorithm using an IEEE 802.11a preamble structure, there is a demand for a new synchronization algorithm which is to be applied to a new frame structure applied to an OFDM SUN system being standardized in IEEE802.15.3a.

The above information disclosed in this Background section is only for enhancement of understanding of the background of the invention, and therefore it may contain information that does not form the prior art that is already known in this country to a person of ordinary skill in the art.

### SUMMARY OF THE INVENTION

The present invention has been made in an effort to provide a method and apparatus for efficiently acquiring synchronization according to a given frame structure in an OFDM-based local wireless communication system.

An exemplary embodiment of the present invention provides a method for acquiring synchronization, the method including: receiving and sampling a reception signal, the reception signal containing an STF (short training field) and data, the STF containing a first number of STF patterns and a second number of STF patterns, the second number of STF patterns having an opposite code to that of the first number of STF patterns; performing first frequency offset estimation on a plurality of STF patterns of the reception signal to acquire a phase error of each sample constituting the STF patterns, and correcting the frequency of the STF patterns based on the acquired phase error; performing second frequency offset estimation on a plurality of STF patterns output subsequent to the first frequency offset estimation and correction to acquire a phase error of each sample constituting the STF patterns, and correcting the frequency of the STF patterns based on the acquired phase error; and performing cross correlation on a predetermined number of STF patterns, among a plurality of STF patterns output subsequent to the second frequency offset estimation and correction, to detect frame timing.

The method may further include finding a position from which STF patterns output subsequent to the detection of the frame timing have an opposite code and detecting the position as a frame boundary.

The first frequency offset estimation and correction may include: calculating a metric value for frequency offset estimation by performing complex multiplication on a set number of STF pattern pairs at a first preset interval and adding the results together; calculating a phase error of each sample constituting the STF patterns by converting the calculated metric value into a phase value and then dividing the phase value by the first interval at which the complex multiplication has been performed; and correcting a frequency offset by calculating a first correction value based on the phase error of each sample and multiplying STF patterns output subsequent to the frequency offset estimation by the calculated first correction value.

The second frequency offset estimation and correction may include: calculating a metric value for frequency offset estimation by performing complex multiplication on a set number of STF patterns at a second preset interval and adding the results together; calculating a phase error of each sample constituting the STF patterns by converting the calculated metric value into a phase value and then dividing the phase value by the second interval at which the complex multiplication has been performed; and correcting a frequency offset by calculating a second correction value based on the phase error of each sample and multiplying STF patterns output subsequent to the frequency offset estimation by the calculated second correction value.

Another embodiment of the present invention provides an apparatus for acquiring synchronization, which acquires synchronization from a reception signal, the apparatus including: a packet detector that detects a packet based on a plurality of STF patterns, the reception signal containing an STF (short training field) and data, the STF containing a first number of STF patterns and a second number of STF patterns, the second number of STF patterns having an opposite code to that of the first number of STF patterns; a gain controller that measures power based on a plurality of STF patterns output subsequent to the packet detection and controls an amplification gain of the reception signal based on the measured power; a first processor that performs first frequency offset estimation on a plurality of STF patterns of the gain-controlled reception signal to acquire a phase error of each sample constituting the STF patterns, and corrects the frequency of the STF patterns based on the acquired phase error; a second processor that performs second frequency offset estimation on a plurality of STF patterns output subsequent to the first frequency offset estimation and correction to acquire a phase error of each sample constituting the STF patterns, and corrects the frequency of the STF patterns based on the acquired phase error; and a timing synchronization unit that performs cross correlation on a predetermined number of STF patterns, among a plurality of STF patterns output subsequent to the second frequency offset estimation and correction, to detect frame timing.

### BRIEF DESCRIPTION OF THE DRAWINGS

FIG. 1 is an exemplary view showing STF values of a frequency domain used in a wireless communication system according to an exemplary embodiment of the present invention.

FIG. 2 is an exemplary view showing STF patterns of a time domain used in a wireless communication system according to an exemplary embodiment of the present invention.

FIG. 3 is an exemplary view showing the values of samples contained in sequences constituting the STF patterns illustrated in FIG. 2.

FIG. 4 is an exemplary view showing a packet detection result according to an exemplary embodiment of the present invention.

FIGS. 5 and 6 are exemplary views showing an auto gain control process according to an exemplary embodiment of the present invention.

FIG. 7 exemplifies a gain control process depending on the level of an input signal.

FIG. 8 is a view showing a frequency offset estimation and correction process for STF patterns according to an exemplary embodiment of the present invention.

FIG. 9 is an exemplary view showing the probability of occurrence of an integer level frequency offset according to the SNR for each channel.

FIG. 10 is a view showing timing synchronization and frame boundary detection processes for STF patterns according to an exemplary embodiment of the present invention.

FIG. 11 is a view showing a structure of a reception device according to an exemplary embodiment of the present invention.

FIG. 12 is a flowchart showing the operation of the reception device according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

Hereinafter, a method and apparatus for acquiring synchronization in a wireless communication system according to an exemplary embodiment of the present invention will be described with reference to the accompanying drawings.

An exemplary embodiment of the present invention provides a method and apparatus for acquiring synchronization by using an STF (short training field) consisting of short training sequences in an orthogonal frequency division multiplexing (OFDM)-based wireless communication system.

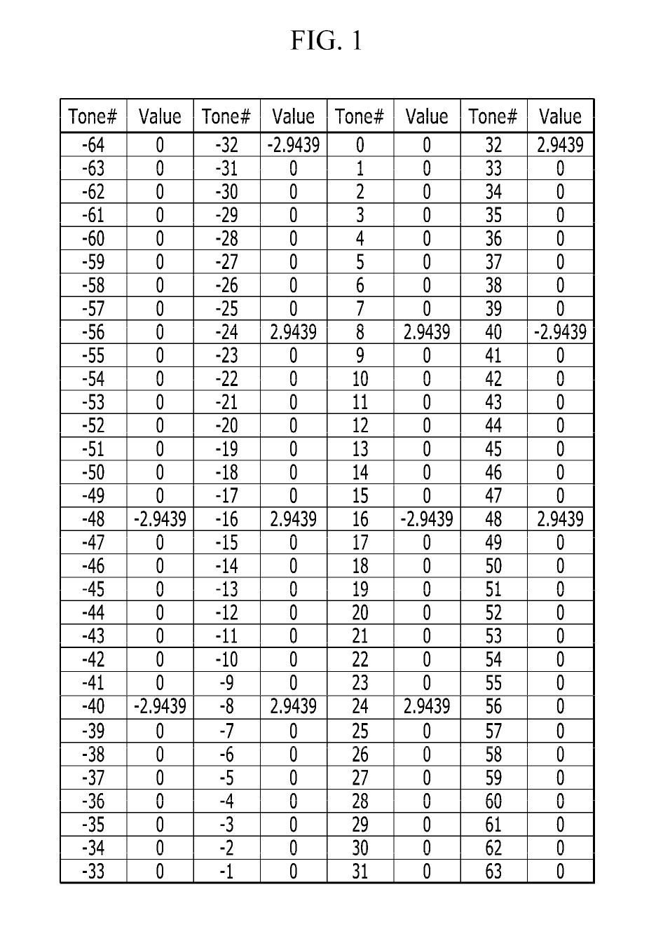

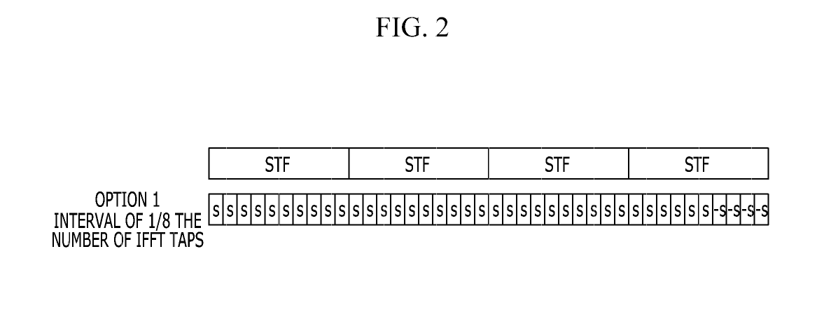

FIG. 1 is an exemplary view showing STF values of a frequency domain used in a wireless communication system according to an exemplary embodiment of the present invention, and FIG. 2 is an exemplary view showing an STF pattern of a time domain.

The attached FIG. 1 shows STF values according to IEEE 802.15.4 g SUN (smart utility network) OFDM Option 1 related to local wireless transmission technology. An STF is used for a preamble to perform synchronization acquisition, automatic gain control (AGC), packet detection, etc., and has a repeated pattern.

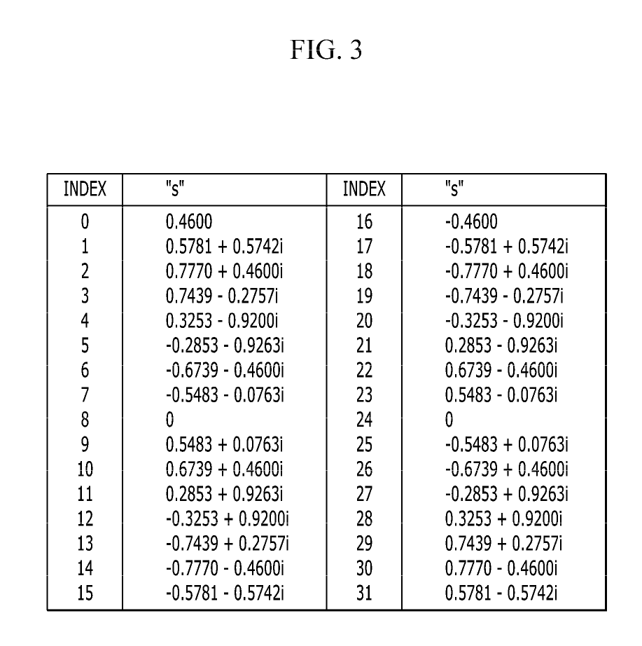

When IFFT (inverse fast Fourier transform) is performed by multiplying STF values of the frequency domain exemplified in FIG. 1 by a set value (e.g., 1.25), STF values in the time domain having an interval of ⅛ the number of IFFT taps are output. Four values having a code opposite to that of the 36th of these STF values are taken and combined with the 36 values, and STF patterns of the time domain including a total of 40 sequences are formed as shown in FIG. 2. In FIG. 2, each “s” denotes a sequence consisting of 32 samples, and the values of these 32 samples are as illustrated in FIG. 3. FIG. 3 is an exemplary view showing the values of samples contained in sequences constituting the STF patterns illustrated in FIG. 2.

Although the method and apparatus for acquiring synchronization to be described hereinafter operate based on STF, the present invention is not necessarily limited to the STF exemplified in FIGS. 1 and 2.

Although the method and apparatus for acquiring synchronization according to an exemplary embodiment of the present invention will be described as operating in an environment where a signal having the above-described STF is transmitted via a fading channel and an AWGN (additive white Gaussian noise) channel while having a frequency error, under the condition that a maximum frequency error of about 37,120 Hz is generated between a transmission device and a reception device, for example, at a 928 MHz band in a local wireless communication system having a tolerance of 20 ppm, the present invention is not limited thereto.

In the exemplary embodiment of the present invention, the transmission device transmits a packet containing an STF having the above-described structure in a plurality of subcarriers, and training sequences S are repeatedly transmitted through the STF. For example, a total of 40 patterns including training sequences are included, the length of each pattern may be 0.8 μs, and each pattern contains 32 data segments.

The reception device receives and processes such a signal. The received signal is sampled and output according to a sampling clock. As used herein, the reception signal is over-sampled two times and then output.

A synchronization acquisition apparatus of the reception device recognizes an STF contained in a sampled reception signal and detects the presence or absence of a packet to perform packet synchronization, and then performs timing synchronization by continuously comparing the reception signal and a reference signal by cross correlation.

Specifically, the synchronization acquisition apparatus detects a frame, i.e., a packet, from the sampled reception signal. Sequences of the STF are used to detect a packet. As used herein, a plurality of “s” patterns as shown in the following Equation 1, rather than one sequence “s” pattern, are used in consideration of a significantly large frequency offset.

$$CC [ m ] = {\sum }_{n = 0}^{3} \{ \vert {\sum }_{k = 0}^{15} STF * [ k ] \times Rx\_in [ m - k - 32 \times n ] \vert + \vert {\sum }_{k = 16}^{31} STF * [ k ] \times Rx\_in [ m - k - 32 \times n ] \vert \} \qquad [ Equation 1 ]$$

Herein, CC[m] denotes a metric value (also referred to as “first metric value”) for detecting a packet in an m-th frame, n denotes the index number of a sequence “s” of the STF, and k denotes the index number of a sample in a sequence “s”. Accordingly, STF*[k] denotes the value of a k-th sample of an n-th sequence “s”. Rx_in denotes a reception signal.

If the metric value CC[m] calculated according to Equation 1 is equal to or more than a set detection value, it is determined that a packet is detected. If the metric value CC[m] is less than the set value, it is determined that no packet is detected.

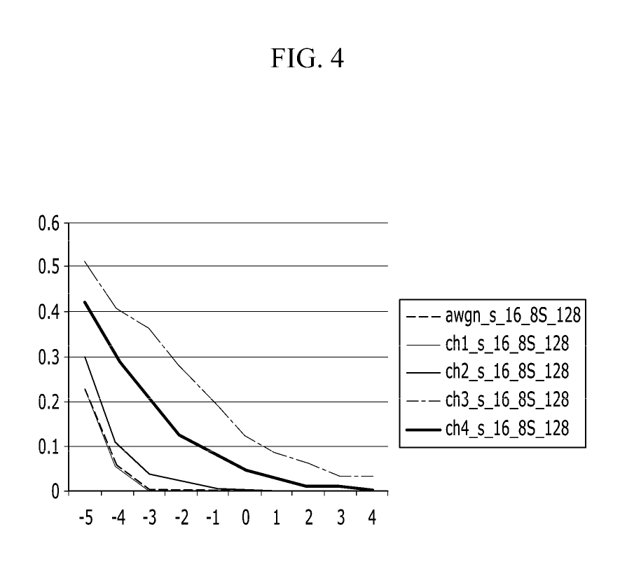

FIG. 4 is an exemplary view showing a packet detection result according to an exemplary embodiment of the present invention. In FIG. 4, “_s” indicates that the code of a reception signal is used, “_{—}16” indicates that correlation is performed every 16 taps, and “8s” indicates that packet detection succeeds if a packet is detected within 8 sequences s. “_{—}128” indicates that correlation accumulation is performed using 128 (16*8) taps.

In the above-described packet detection process according to Equation 1, the value of n can be changed without accumulating the index numbers n from 0 to 3 in Equation 1. In this case, in FIG. 4, the number of taps for correlation, the number of sequences within which packet detection is deemed successful, and so on can be changed, and the packet detection performance may vary with such changes.

Once a packet is detected, auto gain control (AGC) is performed. The power of a reception signal, which is measured during auto gain control, and a preset power value are compared, and an amplification gain of a received analog frame signal is controlled according to a difference between the two powers. In such an auto gain control process, a preset power value is optionally changeable for VGA (variable gain control), and such a preset power value is variable based on power measurement.

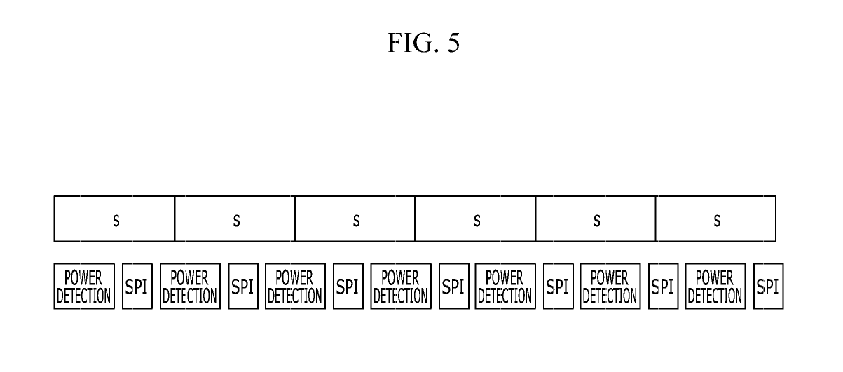

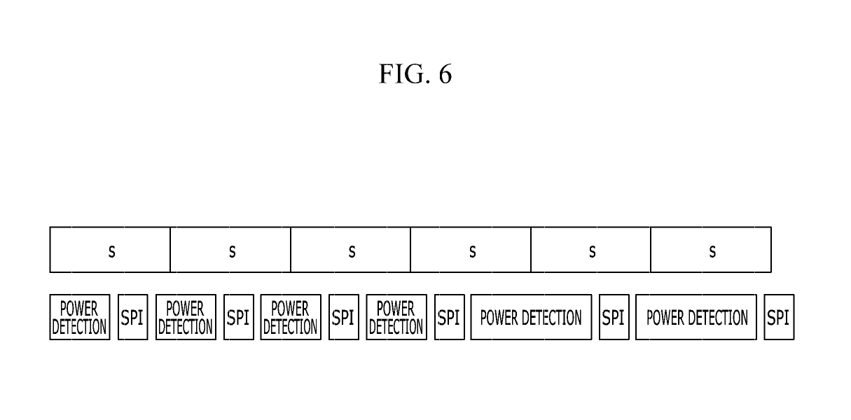

Auto gain control according to an exemplary embodiment of the present invention is repeatedly performed, and FIGS. 5 and 6 are exemplary views showing an auto gain control process according to an exemplary embodiment of the present invention.

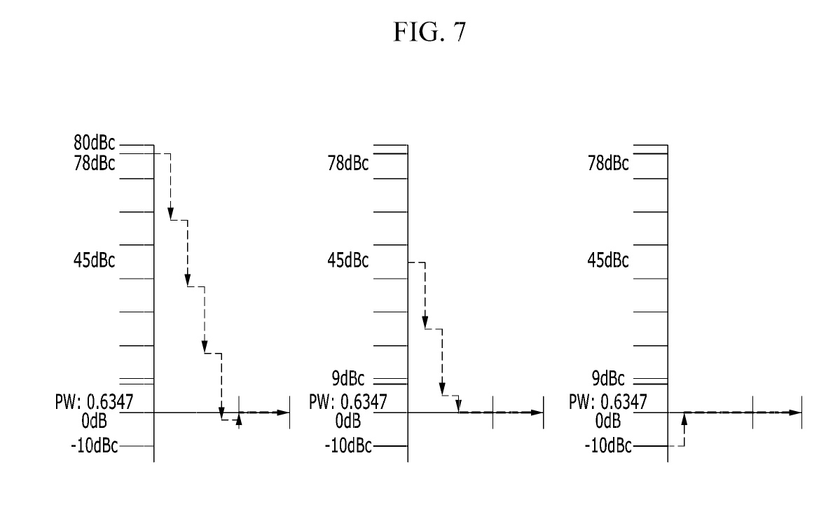

Referring to the attached FIGS. 5 and 6, an operation of detecting power, comparing it with a set power value, and controlling an amplification gain of the reception signal according to a comparison result is repeatedly performed for repeated sequences S of an STF contained in the reception signal output subsequent to the packet detection. By such a repeated automatic gain control process, power saturation as shown in FIG. 7 is achieved. FIG. 7 is an exemplary view showing an auto gain control result according to an exemplary embodiment of the present invention.

As exemplified in FIG. 7, a reception signal input within a variable range of 88 dB can be controlled by auto gain control according to an exemplary embodiment of the present invention. If the reception signal is saturated, the amplifier gain is reduced by 20 dB. Otherwise, gain control is performed according to a preset gain control table. In this case, a unit (power adjustment value) for adjusting dB depending on the level of a reception signal is stored in the gain control table. Thus, gain control is performed after finding an appropriate power adjustment value from the gain control table based on the level of the reception signal. FIG. 7 exemplifies a gain control process depending on the level of an input signal.

After gain control of a reception signal is performed, frequency offset estimation process is performed. A frequency offset estimation (FOE) process according to an exemplary embodiment of the present invention includes first frequency offset estimation (FOE_{—}1) and second frequency offset estimation (FOE_{—}2).

A frequency offset may be generated between a signal transmitted from the transmission device and a signal transmitted from the reception device. For example, the frequency offset is about 37,120 Hz at a 928 MHz band. To prevent an integer level frequency offset, an operation of estimating the generated frequency offset and correcting the frequency of the reception signal based on an estimation result is performed.

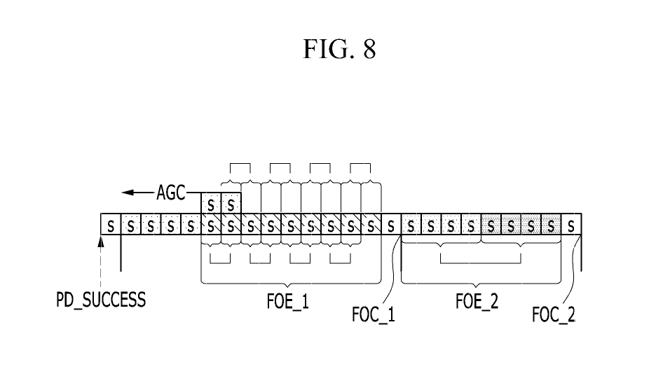

FIG. 8 is a view showing a frequency offset estimation and correction process for STF patterns according to an exemplary embodiment of the present invention.

A reception signal from which a packet is detected has an interval of 32 samples. The reception signal having an interval of 32 samples can be indicated by R[k] (n is the index number of a sequence S, which is an STF pattern, and k is the index number of a sample in a predetermined pattern of an STF).

Frequency estimation is performed using the reception signal having such a repetition characteristic. In general, provided that a subcarrier frequency offset exists, OFDM symbols with conjugate complex symmetry form sample pairs as predetermined numbers of symbols, starting from a reference symbol for conjugate complex symmetry, and are positioned at equal time intervals. As a sample pair of OFDM symbols with conjugate complex symmetry becomes more distant from the reference symbol with conjugate complex symmetry, the phase rotation angle represented by the product of the two samples linearly increases.

In the exemplary embodiment of the present invention, complex multiplication is performed on 8 STF pattern pairs at an interval of 1 sequence, i.e., 1 STF pattern, of an STF, and the results are added together to calculate a metric value for frequency offset estimation. Such a metric value (also referred to as a second metric value) for frequency offset estimation can be calculated by a formula such as Equation 2.

$${\sum }_{n = a}^{a + 7} {\sum }_{k = 1}^{32} {R}^{*} [ n \times 32 + k ] \times R [ ( n + 1 ) \times 32 + k ] \qquad [ Equation 2 ]$$

The second metric value for frequency offset estimation, calculated according to Equation 2, is converted into a phase value, and then divided by the interval at which the complex multiplication has been performed, thereby calculating a phase offset per sample. Once the second metric value is converted into a phase value, the following phase value (theta) is acquired.

$$theta = angle [ {\sum }_{n = a}^{a + 7} {\sum }_{k = 1}^{32} {R}^{*} [ n \times 32 + k ] \times R [ ( n + 1 ) \times 32 + k ] ] \qquad [ Equation 3 ]$$

Herein, * denotes the complex conjugate of a complex number.

The phase value (theta) calculated according to Equation 3 is divided by the interval at which complex multiplication has been performed, i.e., by 32, which is the number of samples, thereby acquiring a phase error

$$( \frac{theta}{32} )$$

of each sample.

A first frequency offset estimation process (FOE_{—}1) is performed by the above procedure, and a first frequency offset correction (FOC) process is performed based on an estimated offset.

In the first frequency offset estimation (FOC_{—}1) process, a frequency offset is corrected by multiplying each sequence of an STF by a first correction value

$$exp ( - j \frac{theta}{32 \times 2 \times π} k )$$

based on the phase error

$$( \frac{theta}{32} )$$

per sample acquired according to the above first frequency offset estimation (FOE_{—}1) process (k is an integer incrementing from 0). Since frequency offset estimation is performed based on 8 pairs of STF patterns, starting from an STF pattern in which a packet is detected, frequency offset correction is performed by multiplying STF patterns, starting from an (a+9)-th STF pattern, by the above correction value. Here, “a” denotes the index number of the first STF pattern in which the first frequency offset correction process is started.

Assuming that an output signal according to the first frequency offset correction (FOC_{—}1) process is RF1[k], the second frequency offset correction (FOE_{—}2) process is performed on a signal on which the first frequency offset correction is performed. The second frequency offset correction (FOE_{—}2) is performed in the same way as the first frequency offset correction (FOE)1) process, except that complex multiplication is performed at an interval of (32×4) samples, and the results are added together, thereby calculating a third metric value for frequency offset estimation as in the following Equation 4.

$$[ {\sum }_{n = a + 9}^{a + 9} {\sum }_{k = 1}^{128} RF {1}^{*} [ n \times 128 + k ] \times RF 1 [ ( n + 1 ) \times 128 + k ] ] \qquad [ Equation 4 ]$$

The third metric value acquired according to Equation 4 is converted into a phase value as follows.

$$theta = angle [ {\sum }_{n = a + 9}^{a + 9} {\sum }_{k = 1}^{128} RF {1}^{*} [ n \times 128 + k ] \times RF 1 [ ( n + 1 ) \times 128 + k ] ] \qquad [ Equation 5 ]$$

The phase value (theta), acquired according to the second frequency offset estimation (FOE_{—}2) process, is divided by the interval at which complex multiplication has been performed, i.e., by (4×32), which is the number of samples, thereby calculating a phase error of

$$\frac{theta}{4 * 32}$$

each sample.

The second frequency offset estimation (FOE_{—}2) process is performed by the above procedure, and a second frequency offset correction (FOC_{—}2) process is performed based on an estimated offset.

In the second frequency offset estimation (FOC_{—}2) process, a frequency offset is corrected by multiplying each pattern of an STF by a second correction value

$$exp ( - j \frac{theta}{4 \times 32 \times 2 \times π} k )$$

based on the phase error

$$( \frac{theta}{4 * 32} )$$

per sample acquired according to the above second frequency offset estimation (FOE_{—}2) process (k is an integer incrementing from 0). Herein, frequency offset correction is performed by multiplying STF patterns, starting from an (a+15)-th STF pattern, by the second correction value.

In the above-described first and second frequency offset estimation process (FOE_{—}1 and FOE_{—}2), frequency offset estimation is properly performed within a range in which an integer level frequency offset is not generated according to the signal to noise ratio (SNR) for each channel.

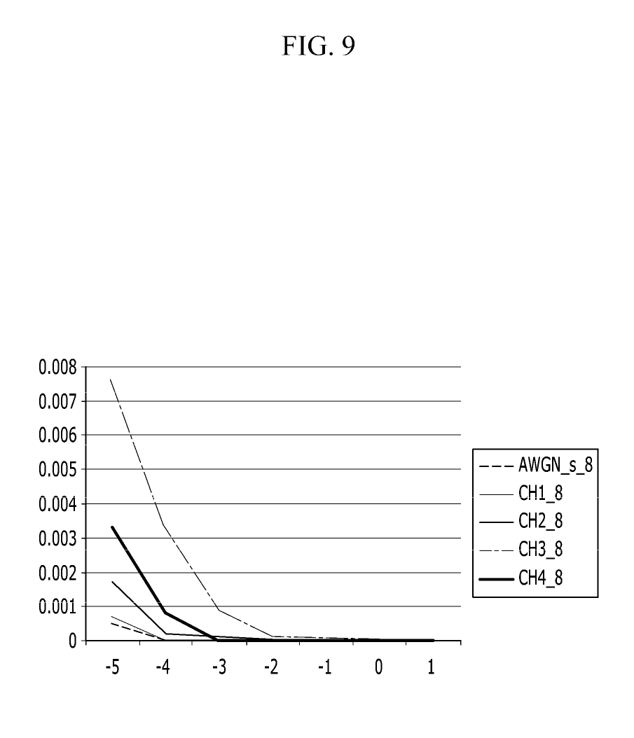

FIG. 9 is an exemplary view showing the probability of occurrence of an integer level frequency offset according to the SNR for each channel. It can be seen that integer level frequency offset estimation is required to further reduce the operation SNR of a frequency offset estimation process frequency error.

After the above-described frequency offset and correction processes are performed, timing synchronization and frame boundary detection processes are performed.

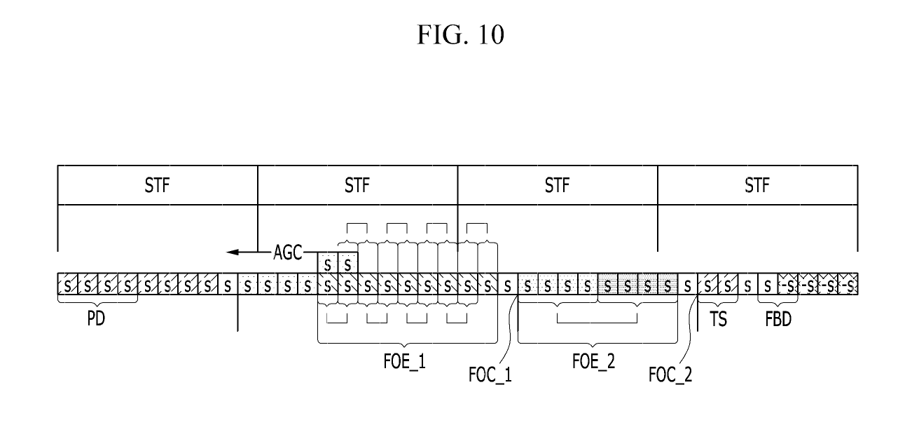

FIG. 10 is a view showing timing synchronization and frame boundary detection processes for STF patterns according to an exemplary embodiment of the present invention.

In the timing synchronization (TS) and frame boundary detection (FBD) processes according to an exemplary embodiment of the present invention, first of all, cross correlation is performed for timing synchronization, as shown in FIG. 10, by using a predetermined number of, i.e., two, STF patterns “s” in a signal output after frequency offset estimation and correction. The timing at which a value obtained by the cross correlation of two STF patterns becomes the highest is detected as frame timing. Here, the number of STF patterns “s” for timing synchronization can be adjusted. By performing timing synchronization detection after the frequency offset estimation and correction processes according to an exemplary embodiment of the present invention, frame synchronization can be detected more accurately, as compared to timing synchronization when the initial frequency offset is large.

Once frame synchronization is detected according to the timing synchronization process, and a frame boundary detection process RFD for detecting a boundary at which a frame is started is performed based on the detected frame synchronization timing, as shown in FIG. 10.

To this end, a position from which a predetermined number of STF patterns have a reverse code is found. An STF according to an exemplary embodiment of the present invention includes a total of 40 STF patterns, as shown in FIG. 2. A given numbered STF pattern has a reverse code. Accordingly, a position from which STF patterns have a reverse code is found in the frame boundary detection process, and is used as a frame boundary. Here, the last 3 STF patterns output subsequent to the STF patterns having a reverse code are ignored.

Next, a reception device that operates according to the above-described method for acquiring reception synchronization will be described.

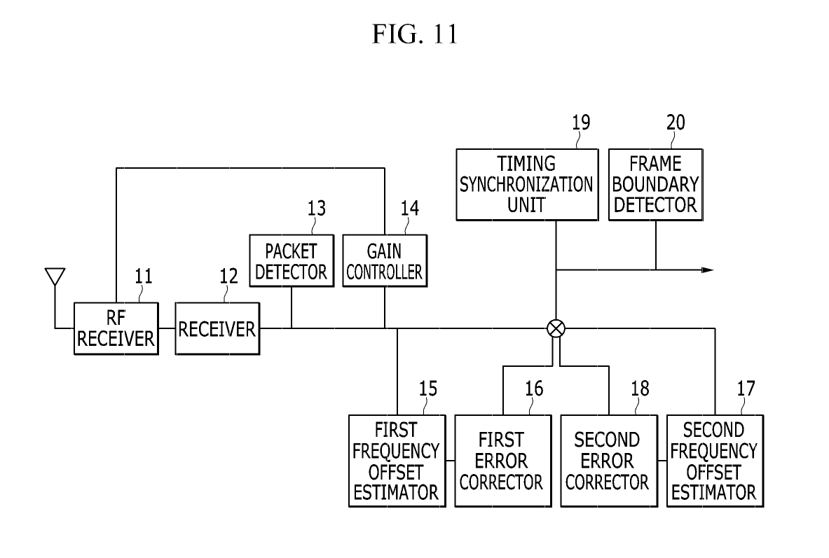

FIG. 11 is a view showing a structure of a reception device according to an exemplary embodiment of the present invention.

As shown in FIG. 11, the reception device according to an exemplary embodiment of the present invention includes an RF (radio frequency) receiver 11, a sampler 12, a packet detector 13, a gain controller 14, a first frequency offset estimator 15, a first offset corrector 16, a second frequency offset estimator 17, a second offset corrector 18, a timing synchronization unit 19, and a frame boundary detector 20.

Here, the packet detector 13, the gain controller 14, the first frequency offset estimator 15, the first offset corrector 16, the second frequency offset estimator 17, the second offset corrector 18, the timing synchronization unit 19, and the frame boundary detector 20 may be collectively referred to as a “synchronization acquisition apparatus”. Also, the first frequency offset estimator 15 and the first offset corrector 16 may be collectively referred to as a “first processor”, and the second frequency offset estimator 17 and the second offset corrector 18 may be collectively referred to as a “second processor”.

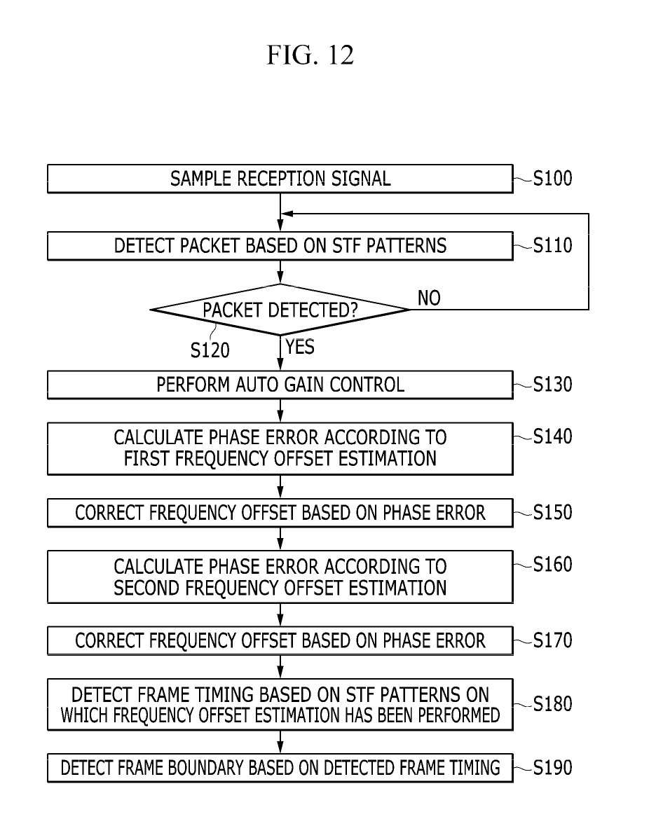

FIG. 12 is a flowchart showing the operation of the reception device according to an exemplary embodiment of the present invention.

As shown in FIG. 12, the transmission device (not shown) transmits a signal containing an STF and data, the STF includes a plurality of repeated STF patterns (s), more particularly, a first number of STF patterns and a second number of STF patterns. The second number of STF patterns has an opposite code to that of the second number of STF patterns.

A signal having such an STF is received and processed by the RF reception device 11 via an antenna, and the sampler 12 samples and outputs the received signal (S100). Here, the sampler 12 over-samples the reception signal two times and then outputs it.

The packet detector 13 recognizes the STF contained in the sampled reception signal and detects the presence or absence of a packet (S110 and S120). Specifically, a first metric value for packet detection is calculated according to Equation 1 by using a plurality of STF patterns. If the calculated first metric value is equal to or more than a set detection value, it is determined that a packet has been detected. If the calculated first metric value is less than the set detection value, it is determined that no packet has been detected.

For a plurality of STF patterns output subsequent to the packet detection, the gain controller 14 repeatedly performs an operation of measuring the power of each signal, comparing it with a set power value, controlling the gain of an amplifier (not shown) of the RF receiver 11 according to the difference between the two power values, and controlling an amplification gain of a received analog frame signal (S130).

After the gain control of the reception signal is performed, the first frequency offset estimator 15 calculates a second metric value for frequency offset estimation by performing complex multiplication on a predetermined number (e.g. 8) of STF pattern pairs at a first interval (e.g., interval of 1 STF pattern, which is equal to 32), for a plurality of STF patterns output subsequent to the gain control, and adding the results together. Then, the second metric value is converted into a phase value, and divided by the first interval at which the complex multiplication has been performed, thereby calculating a phase error of each sample (S140).

The first offset corrector 16 calculates a first correction value based on the phase error per sample estimated by the first frequency offset estimator 15, and STF patterns output after the frequency offset estimation are multiplied by the calculated first correction value, thereby correcting a frequency offset (S150).

Next, the second frequency offset estimator 17 performs frequency offset estimation on signals output subsequent to the frequency offset estimation by the first offset corrector 16. Concretely, complex multiplication is performed on the STF patterns at a second interval (e.g., interval of (32×4) samples), and the results are added together, thereby calculating a third metric value for frequency offset estimation. Then, the third metric value is converted into a phase value, and then divided by the second interval at which the complex multiplication has been performed, thereby calculating a phase error of each sample (S160).

The second offset corrector 18 calculates a second correction value based on the phase error per sample estimated by the second frequency offset estimator 17, and STF patterns output after the frequency offset estimation by the second frequency offset estimator 17 are multiplied by the calculated second correction value, thereby correcting a frequency offset (S170).

After frequency offset estimation and correction are performed by the first and second frequency offset estimators 15 and 17 and the first and second offset correctors 16 and 18, the timing synchronization unit 19 performs cross correlation on a predetermined number of STF patterns in an output signal. The timing at which a value obtained by cross correlation becomes the highest is detected as frame timing (S180).

Upon detection of frame timing, the frame boundary detector 20 detects a boundary at which a frame is started, based on the detected frame timing (S190). That is, a position from which STF patterns output subsequent to the detection of the frame timing have a reverse code is found. In other words, a position from which the second number of STF patterns having an opposite code to that of the first number of STF patterns is started is found. The thus-detected position is used as a frame boundary.

The reception device 1 is able to acquire subsequent data based on the frame boundary detected through this procedure.

According to an exemplary embodiment of the present invention, synchronization can be acquired easily and efficiently from a reception signal having a frame structure including an STF (short training field) consisting of repeated patterns in a local wireless communication system.

Embodiments of the present invention are not only realized by the method and device, but are also realized by a program for realizing the functions corresponding to the configuration of embodiments of the present invention or a recording medium for recording the program, which can be easily realized by a person skilled in the art.

While embodiments of this invention has been described, it is to be understood that the invention is not limited to the disclosed embodiments, but, on the contrary, is intended to cover various modifications and equivalent arrangements included within the spirit and scope of the appended claims.

What is claimed is:

1. A method for acquiring synchronization, the method comprising:
receiving and sampling a reception signal, the reception signal containing an STF (short training field) and data, the STF containing a first number of STF patterns and a second number of STF patterns, the second number of STF patterns having an opposite code to that of the first number of STF patterns;
performing first frequency offset estimation on a plurality of STF patterns of the reception signal to acquire a phase error of each sample constituting the STF patterns, and correcting the frequency of the STF patterns based on the acquired phase error;
performing second frequency offset estimation on a plurality of STF patterns output subsequent to the first frequency offset estimation and correction to acquire a phase error of each sample constituting the STF patterns, and correcting the frequency of the STF patterns based on the acquired phase error; and
performing cross correlation on a predetermined number of STF patterns, among a plurality of STF patterns output subsequent to the second frequency offset estimation and correction, to detect frame timing.

2. The method of claim 1, further comprising finding a position from which STF patterns output subsequent to the detection of the frame timing have an opposite code and detecting the position as a frame boundary.

3. The method of claim 1, wherein the first frequency offset estimation and correction comprises:
calculating a metric value for frequency offset estimation by performing complex multiplication on a set number of STF pattern pairs at a first interval and adding the results together;
calculating a phase error of each sample constituting the STF patterns by converting the calculated metric value into a phase value and then dividing the phase value by the first interval at which the complex multiplication has been performed; and
correcting a frequency offset by calculating a first correction value based on the phase error of each sample and multiplying STF patterns output subsequent to the frequency offset estimation by the calculated first correction value.

4. The method of claim 3, wherein, in the calculation of the metric value, the metric value is calculated by performing complex multiplication on a plurality of STF pattern pairs at an interval of one STF pattern and adding the results together.

5. The method of claim 1, wherein the second frequency offset estimation and correction comprise:
calculating a metric value for frequency offset estimation by performing complex multiplication on a set number of STF patterns at a second preset interval and adding the results together;
calculating a phase error of each sample constituting the STF patterns by converting the calculated metric value into a phase value and then dividing the phase value by the second interval at which the complex multiplication has been performed; and
correcting a frequency offset by calculating a second correction value based on the phase error of each sample and multiplying STF patterns output subsequent to the frequency offset estimation by the calculated second correction value.

6. The method of claim 1, further comprising:
calculating a metric value for packet detection by using the plurality of STF patterns contained in the sampled and output reception signal; and
if the calculated metric value is equal to or more than a set detection value, determining that a packet is detected, and if the calculated metric value is less than the set detection value, determining that no packet is detected.

7. The method of claim 6, wherein, in the calculation of the metric value for packet detection, the metric value is calculated by using a correlator having half the length of each of the plurality of STF patterns.

8. The method of claim 6, further comprising, for a plurality of STF patterns output subsequent to the packet detection, measuring the power of each signal and comparing the measured power with a preset power value, and then controlling an amplification gain of the reception signal according to the difference between the two power values,
wherein the first frequency offset estimation and correction are performed after the gain control.

9. An apparatus for acquiring synchronization, which acquires synchronization from a reception signal, the apparatus comprising:
a packet detector that detects a packet based on a plurality of STF patterns, the reception signal containing an STF (short training field) and data, the STF containing a first number of STF patterns and a second number of STF patterns, the second number of STF patterns having an opposite code to that of the first number of STF patterns;
a gain controller that measures power based on a plurality of STF patterns output subsequent to the packet detection and controls an amplification gain of the reception signal based on the measured power;
a first processor that performs first frequency offset estimation on a plurality of STF patterns of the gain-controlled reception signal to acquire a phase error of each sample constituting the STF patterns, and corrects the frequency of the STF patterns based on the acquired phase error;
a second processor that performs second frequency offset estimation on a plurality of STF patterns output subsequent to the first frequency offset estimation and correction to acquire a phase error of each sample constituting the STF patterns, and corrects the frequency of the STF patterns based on the acquired phase error; and
a timing synchronization unit that performs cross correlation on a predetermined number of STF patterns, among a plurality of STF patterns output subsequent to the second frequency offset estimation and correction, to detect frame timing.

10. The apparatus of claim 9, wherein the timing synchronization unit finds a position from which STF patterns output subsequent to the frame timing detection have an opposite code, and detects the position as a frame boundary.

11. The apparatus of claim 9, wherein the first processor calculates a metric value for frequency offset estimation by performing complex multiplication on a set number of STF pattern pairs at a first preset interval and adding the results together; and calculates a phase error of each sample constituting the STF patterns by converting the calculated metric value into a phase value and then dividing the phase value by the first interval at which the complex multiplication has been performed.

12. The apparatus of claim 11, wherein the second processor calculates a metric value for frequency offset estimation by performing complex multiplication on a set number of STF patterns at a second preset interval and adding the results together, and calculates a phase error of each sample constituting the STF patterns by converting the calculated metric value into a phase value and then dividing the phase value by the second interval at which the complex multiplication has been performed.

13. The apparatus of claim 11, wherein the packet detector calculates the metric value by using a correlator having half the length of each of the plurality of STF patterns.
